(19) United States
(12) Patent Application Publication
(10) Pub. No.: US 2024/0354683 A1
(43) Pub. Date: Oct. 24, 2024

(54) DISTRIBUTION-BASED SUPERVISED APPROACH FOR PEER BENCHMARKING

(71) Applicant: Intuit, Inc., Mountain View, CA (US)

(72) Inventors: Arnab CHAKRABORTY, Bangalore (IN); Sourav PROSAD, Bangalore (IN)

(21) Appl. No.: 18/137,373

(22) Filed: Apr. 20, 2023

(51) Int. Cl. G06Q 10/0639

(52) U.S. Cl. CPC G06Q 10/06393

(57) ABSTRACT

Certain aspects of the disclosure provide a method of benchmarking a target entity. The method generally includes, for each respective entity characteristic in a set of entity characteristics and starting with a first entity characteristic: determining a wide distribution comprising dissimilarity metric values associated with the respective entity characteristic and measured between the target entity and each entity in a current set of entities; determining subsets of entities within the current set of entities; for each respective subset: determining a narrow distribution comprising dissimilarity metric values associated with the respective entity characteristic and measured between the target entity and each entity in the respective subset; resetting the current set of entities to include only a subset of entities in the subsets of entities having a highest benchmark score; and determining benchmark data for the target entity based on the current set of entities.

### BACKGROUND

### Field

Aspects of the present disclosure relate to peer benchmarking, and more specifically, to peer group determination for generating benchmark data for a target entity.

### Description of Related Art

Peer benchmarking is the process of measuring an entity's performance, products, services, and/or processes against industry peers (simply referred to herein as “peers”) belonging to a same peer group as the entity. A peer group refers to a group of one or more organizations that share similar characteristic(s) with one another, such as, for example, industry type, type of products, number of employees, location, and/or the like. Peer benchmarking generally involves comparing the entity's data to data of its peers to help, for example, determine where the entity is preforming relative to its competition, identify areas for improvement, and/or aid strategic decision making, to name a few.

In some cases, peer benchmarking is used as a way to make a comparison of key performance indicators (KPIs) in order to assess an entity's overall competitiveness, efficiency, and/or productivity (known in the art as “benchmarking”). For example, financial KPIs include revenue, expenses, wages paid, net profit margin (NPM), gross profit margin (GPM), and/or the like. Timely and accurate financial benchmark performance data allows an entity to evaluate their strengths and weaknesses, mitigate risks, uncover opportunities, and/or improve performance.

Grouping entities into different peer groups for performing benchmarking presents a difficult technical problem, however. In particular, no standard exists for defining a peer group across domains. Inconsistent schemes for forming peer groups for benchmarking results in inconsistent and potentially incorrect insights. For example, different criteria, such as amounts and/or types of entity characteristics, may be used to sort entities into various peer groups. As such, what constitutes an “accurate” peer group for an entity to perform financial benchmarking is unknown.

Thus a technical problem exists in the art with respect to peer group determination. Because benchmarking and benchmark-derived insights provide improved performance across myriad domains, there is a need for improved techniques for determining a benchmarking peer group.

### SUMMARY

Certain embodiments provide a method for benchmarking a target entity. The method generally includes, for each respective entity characteristic in a set of entity characteristics and starting with a first entity characteristic, determining a wide distribution comprising dissimilarity metric values associated with the respective entity characteristic and measured between the target entity and each entity in a current set of entities and comprising the respective entity characteristic. Further, for each respective entity characteristic, the method generally includes determining a plurality of subsets of entities within the current set of entities and comprising the respective entity characteristic. Additionally, for each respective entity characteristic, the method generally includes determining a plurality of subsets of entities within the current set of entities and comprising the respective entity characteristic. The method generally includes, for each respective subset of entities in the plurality of subsets of entities within the current set of entities, determining a narrow distribution comprising dissimilarity metric values associated with the respective entity characteristic and measured between the target entity and each entity in the respective subset of entities and determining a benchmark score for the respective subset of entities. Further, for each respective entity characteristic, the method generally includes resetting the current set of entities to include only a subset of entities in the plurality of subsets of entities having a highest benchmark score. The method generally includes determining benchmark data for the target entity based on the current set of entities.

Certain embodiments provide a method for benchmarking a target entity. The method generally includes, for each respective entity characteristic in a set of entity characteristics, determining a first wide distribution comprising first dissimilarity metric values associated with the respective entity characteristic and measured between the target entity and each entity in a set of entities and comprising the respective entity characteristic. Further, for each respective entity characteristic in a set of entity characteristics, the method generally includes determining a plurality of first subsets of entities within the set of entities and comprising the respective entity characteristic. For each respective first subset of entities, the method generally includes determining a first narrow distribution comprising first dissimilarity metric values associated with the respective entity characteristic and measured between the target entity and each entity in the respective first subset of entities, determining a first benchmark score for the respective first subset of entities, and associating the first benchmark score with the respective entity characteristic. For each respective entity characteristic in a set of entity characteristics, the method generally includes setting as a first entity characteristic the entity characteristic of the set of entity characteristics associated with a highest first benchmark score. Further, the method generally includes, for each respective entity characteristic in the set of entity characteristics and starting with the first entity characteristic, determining a second wide distribution comprising second dissimilarity metric values associated with the respective entity characteristic and measured between the target entity and each entity in a current set of entities and comprising the respective entity characteristic. For each respective entity characteristic in the set of entity characteristics and starting with the first entity characteristic, the method generally includes determining a plurality of second subsets of entities within the current set of entities and comprising the respective entity characteristic. For each respective second subset of entities, the method generally includes determining a second narrow distribution comprising second dissimilarity metric values associated with the respective entity characteristic and measured between the target entity and each entity in the respective second subset of entities and determining a second benchmark score for the respective subset of entities. For each respective entity characteristic in the set of entity characteristics and starting with the first entity characteristic, the method generally includes resetting the current set of entities to include only a second subset of entities in the plurality of second subsets of entities having a highest second benchmark score. The method generally includes determining benchmark data for the target entity based on the current set of entities.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### DESCRIPTION OF THE DRAWINGS

The appended figures depict certain aspects and are therefore not to be considered limiting of the scope of this disclosure.

FIG. 1 illustrates an example system for benchmarking a target entity.

FIG. 2 illustrates an example method of benchmarking a target entity.

FIGS. 3A-3D illustrate example peer group determination for generating benchmark data for a target entity.

FIG. 4 illustrates example benchmark data generated for a target entity.

FIG. 5 illustrates an example processing system on which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Determining peer groups for generating benchmarking insights is a technically challenging problem. For example, determining the right number and/or types of entity characteristics, from a large pool of entity characteristics, to consider when creating peer groups is difficult where there is no standard and domain-agnostic approach for making this determination. Rather, conventional methods for creating peer groups tend to be subjective rather than analytical, and peer groups formed by these conventional methods are subject to issues such as survivor bias, composition bias, and/or mismatches between one or more entities belonging to a same peer group. Accordingly, insights generated based on a faulty peer group's data may not provide an accurate, or realistic, estimate of how well a target entity performs compared to its actual peers.

A conventional approach to creating peer groups is the use of hard-coded rules for creating the peer groups. In particular, rule-based systems use “if-then” rules to, for example, sort entities into their respective peer groups. By way of example, Company A being located in Austin, Texas may be matched to geographic peers according to a rule that “If a company is located anywhere in Texas, then that company belongs to a peer group.” While rule-based systems are relatively easy to understand and provide transparency to peer group creation, such systems have inherent technical weaknesses. First, rule-based systems are only as good as the underlying rules that make up the system, and these rules are typically human-generated, as opposed to being learned (e.g., thereby limiting scalability of this approach). That is, such rules are formed by a subjective, rather than analytical, approach. When a large number of variables are involved in defining peer groups, it is impractical for humans to formulate an accurate and exhaustive set of rules; in other words, such rules are not amenable to human mental processes. Moreover, the more individual knowledge a user adds, e.g., by adding more rules, the more complex and opaque the system becomes.

Second, rule-based systems generally require complete information for any attribute being addressed by a rule and therefore do not handle incomplete or incorrect information. For example, an entity that does not have data for comparison against a particular rule may be ignored, thereby leading, in some cases, to survivor bias issues in a resulting peer group.

Third, rule-based systems are generally not capable of incorporating user feedback to dynamically and effectively modify the definition of different peer groups.

Other conventional approaches for forming peer groups include unsupervised learning techniques, such as clustering. Clustering generally refers to the task of dividing a plurality of entities into an arbitrary number of clusters (groups) so that entities in a cluster tend to be more similar than entities outside of the cluster. K-means clustering or agglomerative clustering can thus be used to determine clusters as peer groups. K-means is a centroid-based clustering algorithm, where distances are calculated between like characteristics of different entities and a target entity to determine cluster assignments (e.g., to form a peer group). Agglomerative clustering uses pairwise distance metrics calculated between similar characteristics of different entities to generate the clusters of similar entities (e.g., peer groups). Both of these clustering methods use distance metrics as a means for forming clusters, and these distance metrics are sensitive to missing data. As such, missing data (e.g., missing characteristics for one or more entities) presents a technical problem for such methods.

Further, clustering algorithms like K-Means require a user to essentially guess how many clusters there should be, and the results of the clustering can be skewed significantly when the number of clusters is chosen poorly. When applied to forming peer groups, this can result in peer groups that are too large (e.g., when too few clusters are selected) or too small (when too many clusters are selected) to provide accurate and truly customized peer group-based benchmarks and related insights.

Accordingly, conventional methods for determining peer groups to generate benchmarking insights, such as rule-based approaches, clustering, and/or other unsupervised approaches, are not effective and suffer from many technical deficiencies.

Embodiments described herein overcome the aforementioned technical problems and improve upon the state of the art by providing an approach for benchmarking a target entity that utilizes distributional insights when defining a peer group for the target entity. In particular, aspects herein include generating distributions of data associated with different candidate peer groups possible for a target entity. The distributions are based on dissimilarity metric values that define the “closeness” between entities in each peer group to the target entity for a particular entity characteristic.

Distributions created for the different candidate peer groups demonstrate how significant, or interesting, a corresponding peer group is, as well as, demonstrate a level of variance in data provided by the peer group. For example, a peer group having a large number of entities may include a smaller percentage of entities similar to a target entity. As such, distributions created for these peer groups may demonstrate a large variance in data for the peer group; however, the distribution may be trivial (e.g., data may be less important when compared to a target entity). On the other hand, a peer group having a smaller number of entities may include a larger percentage of entities similar to a target entity. As such, distributions created for these peer groups may be more interesting with respect to the target entity, however, demonstrate a smaller variance in data for the peer group.

Data variance for a peer group is important to help ensure that the peer group provides enough data to confidently generate benchmark data for the target entity. Further, similarity of the peer group to the target entity is also important when generating benchmark data for the target entity (e.g., referred to herein as significance or interestingness). The distributions created provide insights into both the (1) significance and (2) variance/confidence offered by the different peer groups for the target entity, such that a “best” peer group can be chosen for the target entity. A “best” peer group is a peer group that is the least trivial (e.g., most significant or interesting distributional difference) while also providing the greatest variance of data (e.g., most confident distributional difference). In some examples described herein, the distributions are depicted by boxplots (e.g., generally used to graphically demonstrate the locality and spread for groups of numerical data) to display.

In some aspects, a method is provided for iteratively (1) performing marginal dissimilarity metric computation for an entity characteristic shared between a target entity and candidate peer group of entities, (2) creating distributions for all possible subsets of candidate peer group entities using the computed marginal dissimilarity metrics, and (3) identifying a subset of candidate peer group entities that provides the most significant (e.g., least trivial) and confident distributional difference between the identified subset of candidate peer group entities and all other subsets of candidate peer group entities. Creating distributions for all possible subsets of candidate peer group entities includes creating a distribution for a first subset including all candidate peer group entities (e.g., referred to herein as a “wide distribution”), creating a distribution for a second subset including only the target entity (e.g., referred to herein as a “narrow distribution”), and creating distributions for all other subsets in between (e.g., also referred to herein as “narrow distributions”). A subset of candidate peer group entities that provides the most significant and confident distributional difference is a subset of candidate peer group entities having a highest benchmark score.

In some aspects, a benchmark score is calculated as the negative log of a p-value of a statistical hypothesis test of whether the narrow distribution associated with a subset of candidate peer group entities is the same as the wide distribution associated with the a subset including all candidate peer group entities. A subset including all candidate peer group entities may be the most trivial (e.g., least significant) subset, yet provide the greatest variance in data. Accordingly, by comparing the narrow distribution associated with the subset of candidate peer group entities to the wide distribution associated with the subset including all candidate peer group entities, a level of significance and confidence provided by the narrow distribution may be determined.

Aspects described herein thus compute marginal dissimilarity metrics, create distributions, and identify a subset of candidate peer group entities having a highest benchmark score for each entity characteristic that is to be considered when determining a peer group for a target entity. For example, a first iteration involves calculating dissimilarity metrics, creating distributions, and identifying a first subset of candidate peer group entities having a highest benchmark score for a first entity characteristic. The system then attempts to further narrow this first subset of candidate peer group entities by calculating dissimilarity metrics and creating distributions for a second entity characteristic and for second subsets of candidate peer group entities, where the second subsets of peer group entities include only entities belonging to the identified first subset of candidate peer group entities. The system then identifies a second subset of candidate peer group entities that has a highest benchmark score for the second entity characteristic. This process is performed iteratively for each entity characteristic until all entity characteristics have been considered. The final subset of candidate peer group entities is determined to be the peer group for the target entity. Data for the peer group is then compared to data of the target entity to generate benchmark data for the target entity.

Aspects described herein provide significant technical advantages over conventional solutions, including those described above. For example, aspects described herein identify a peer group that is the least trivial (e.g., most significant or interesting distributional difference) while also providing the greatest variance of data (e.g., most confident distributional difference) among other possible peer groups for performing peer benchmarking. This technical effect overcomes technical problems of low benchmark data accuracy, due to insufficiently interesting and/or confident peer groups determined using conventional approaches. For example, unlike conventional approaches that attempt to guess the correct number of clusters and/or the entities that belong to each cluster, aspects herein provide a method that calculates a benchmark score for each possible subset of entities, and further for each entity characteristic considered, in order to identify peer groups that provide a sufficient amount of entities to make a valid comparison of the entity data to a target entity when generating benchmark data for a target entity, as well provide entities that are sufficiently similar to the target entity.

Further, aspects described herein are effective even when entities are missing data for one or more characteristics. For example, if data for an entity characteristic is missing, then no comparison is made for that characteristic, which avoids fouling a conventional distance metric such as used by conventional clustering algorithms. Beneficially then, comparing characteristics marginally between entities makes aspects described herein more resistant to multicollinearity between entity characteristics, where multicollinearity refers to correlation among independent variables (e.g., in this case, entity characteristics).

Aspects described herein are also highly scalable. In particular, because peer benchmarking according to the methods described herein do not require generating a pairwise distance matrix (e.g., a two-dimensional array containing the distances, taken pairwise, between the characteristics of different entities in a pool of candidate per group entities) for computation of the peer groups, less computation energy and less memory consumption is required. As such, aspects described herein function well even when the number of entities and/or entity characteristics increases. For example, a database including information about 100,000 candidate peer group entities may result in creating and storing a 100,000×100,000 distance matrix (10⁵×10⁵ distance matrix) in memory where K-means clustering is used to determine the peer groups. To the contrary, aspects described herein, may only require a marginal dissimilarity matrix having an amount of rows equal to (10⁵[(10⁵−1)/2]−10⁵) and an amount of columns equal to P, where P represents the number of factors used for defining the peer group, x P, where P is XXX and is less than 10⁵. to be stored in memory for each entity. This reduction in matrix size has the beneficial technical effects of reducing computational complexity, computational energy use, and memory use. Further, peer computation across entities may be parallelized, which results in reduced computational time. For example, aggregation of the dissimilarities across the P features, as well as uploading the entire dissimilarity matrix in memory, is not necessary. Instead, massive parallelization techniques (e.g., using Apache Spark™) may be used to compare candidates for identifying the peer groups.

Notably, the improved peer benchmarking approaches described herein can further improve the function of any existing application that provides benchmarking insights, including any application that analyzes peer data to generate benchmark data for a target entity. In this way, benchmark data provided to a target entity (e.g., a user associated with a target entity) may provide a more accurate estimate of how well the target entity compares to its peers.

### Example System for Benchmarking a Target Entity

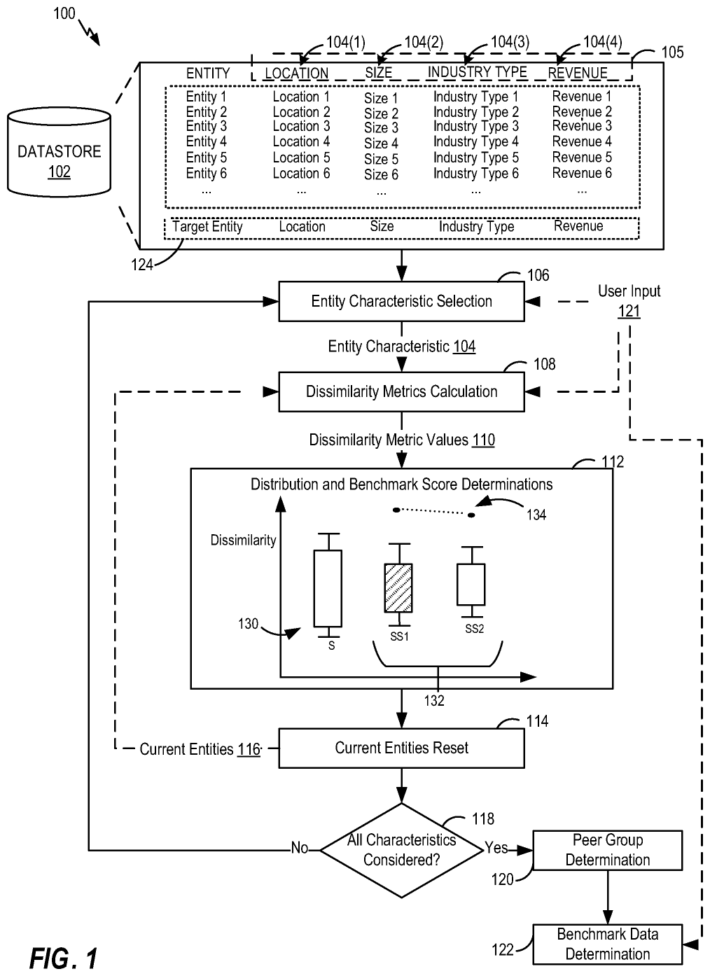

FIG. 1 illustrates an example system 100 for benchmarking a target entity. As illustrated, system 100 is configured to determine a peer group for the target entity, from a set of entities, using distributional insights. In some aspects, the determined peer group is a subset (SS) of entities from a set (S) of entities that provides the most significant and confident distributional difference (e.g., measured via a statistical test) among other subsets of entities from the set of entities. Once an appropriate peer group is determined for a target entity, then the target entity may be benchmarked against other entities within the peer group. Generally, the benchmarking is both more customized and more accurate owing to the improved method of determining the peer group as compared to conventional methods.

To determine the peer group, system 100 begins by selecting, at 106, an entity characteristic 104 to analyze. In this example, entity characteristics 104 are features associated with different entities that are used to form different peer groups. For example, entities associated with a first value for an entity characteristic 104 (e.g., industry type is glass manufacturer) may belong to a first peer group while entities associated with a second value for the entity characteristic 104 (e.g., industry type is dog groomer) may belong to a second peer group. Example entity characteristics 104 include entity type (e.g., LLC, privately owned, publicly traded, etc.), location (e.g., city, state, address of entity, postal code of entity, geographic coordinates of entity, etc.), size (e.g., employee number), industry type, North American Industry Classification System (NAICS) (e.g., the standard used by Federal statistical agencies in classifying entities), Standard Industrial Classification (SIC) code, and any manner of financial metrics (e.g., current ratio, gross profit (margin), net burn, net profit (margin), leverage, revenue, and earnings before interest, taxes, depreciation, and amortization (EBITDA), etc.), to name a few.

In FIG. 1, entity characteristics 104 illustrated include a location entity characteristic 104(1), a size entity characteristic 104(2), an industry type entity characteristic 104(3), and a revenue entity characteristic 104(4), which are collectively referred to herein as entity characteristics 104. Entity characteristics 104 may belong to a set of entity characteristics 105 maintained in datastore 102 for different entities. Datastore 102 stores information about different entities and their corresponding entity characteristic 104 values.

An entity characteristic 104 selected first among other entity characteristics 104 (e.g., in the set of entity characteristics 105) for analysis is referred to herein as a “first entity characteristic 104.” In certain embodiments, the first entity characteristic 104 is selected, at 106, at random. Alternatively, in certain embodiments, the first entity characteristic 104 is selected, at 106, based on user input 121. In various embodiments, a user may specify the first entity characteristic 104 to be analyzed when determining the peer group, the particular entity characteristic(s) 104 to be analyzed, the particular entity characteristic(s) 104 that are not be analyzed, the order of analyzing different entity characteristics 104, etc. For example, user input 121 may indicate that both revenue entity characteristic 104(4) and location entity characteristic 104(1) are to be considered when determining the peer group, and location entity characteristic 104(1) is to be analyzed first.

Although not meant to be limiting to this particular example, in FIG. 1, the first entity characteristic 104 selected, at 106, is location entity characteristic 104(1).

At 108, system 100 calculates dissimilarity metric values 110 associated with the selected first entity characteristic 104. Dissimilarity metric values 110 define the “closeness” between any two given entities with respect to a particular entity characteristic 104. As such, dissimilarity metric values 110 are measured between target entity 124 and each entity in a current set of entities. For example, a dissimilarity metric value 110, D(E1, E2, X), is measured between two entities (e.g., a first entity, E1, and a second entity, E2) with respect to target entity characteristic, X (e.g., revenue, location, etc.). Dissimilarity metric value 110, D(E1, E2, X) is always non-negative. Further, a lower D(E1, E2, X) indicates that entities, E1 and E2, are more similar with respect to entity characteristic X, while a higher D(E1, E2, X) indicates that entities, E1 and E2, are less similar with respect to entity characteristic X. When D(E1, E2, X)=D(E2, E1, X), then the entities, E1 and E2, are identical (e.g., symmetric) with respect to entity characteristic X. For example, where E1 and E2 are both labeled as glass manufacturers (e.g., an industry type entity characteristic value), then E1 and E2 are identical with respect to industry type (e.g., D(E1, E2, X)=D(E2, E1, X), where X is industry type).

As used herein, dissimilarity metric values 110, also referred to as divergence metric values, are different from distance metric values. In particular, while distance metric values always satisfy the triangle inequality, the same does not necessarily hold true for dissimilarity metric values 110, used herein. A distance metric is a function that defines a distance between each pair of elements of a set. Unlike a dissimilarity metric, a distance metric requires triangle inequality, or in other words, requires that for three elements in a set (x, y, z), the sum of the distances for any two pairs must be greater than the distance for the remaining pair (e.g., d(x,z)≤d(x,y)+d(y,z)). Requiring triangle inequality reduces coverage and increases memory overhead. Thus, by calculating dissimilarity metric values 110 that do not require triangle inequality, coverage, as well as computation of the different peer groups, is improved.

At 108, dissimilarity metric values 110 are measured between target entity 124 and each entity in a current set of entities. Because this is the first entity characteristic 104 being analyzed in the set of entity characteristics 105, the current set of entities includes all entities in datastore 102. However, as described in detail below, the current set of entities may change each time a new entity characteristic 104 is selected for an iterative analysis.

Determining the dissimilarity metric values 110, at 108, may be different for different entity characteristics 104. For example, in certain embodiments where the entity characteristic 104 to be analyzed (e.g., selected at 106) is location entity characteristic 104(1), determining the dissimilarity metric values 110 includes calculating a Haversine distance between the location for target entity 124 (e.g., stored in datastore 102) and the location for each entity in the current set of entities (e.g., also stored in datastore 102). The Haversine distance is the shortest distance between two points on the surface of a sphere (e.g., the shortest distance between the location for target entity 124 and a location of an entity in the current set of entities on Earth). For example, location data included in datastore 102 for target entity 124 and other entities in the current set of entities may include postal codes. As such, a Haversine distance may be calculated between the postal code for target entity 124 and the postal code for each of the other entities to generate multiple dissimilarity metric values 110 for the location entity characteristic 104(1).

In certain embodiments, where the entity characteristic 104 to be analyzed (e.g., selected at 106) is a financial KPI value (e.g., a financial feature over a period of time, such as revenue over the last 12 months), the dissimilarity metric values 110 may be based on a Euclidean distance (or dynamic time warping (DTW) distance) between the financial KPI value for target entity 124 (e.g., stored in datastore 102) and the financial KPI value for each entity in the current set of entities (e.g., also stored in datastore 102). The Euclidean distance is the length of a segment connecting two points in either a plane or in three-dimensional space. DTW is an algorithm for measuring the similarity between two temporal time series sequences, which may vary in speed or length. The main idea of DTW is to compute the DTW distance from the matching of similar elements in the two time series. For example, the financial KPI may be revenue obtained by the entity over the last twelve months. As such, revenue over the last twelve months may be aggregated for target entity 124 and each entity in the current set of entities and then a Euclidean distance may be calculated.

In certain embodiments, where the entity characteristic 104 to be analyzed (e.g., selected at 106) is a financial KPI value, determining the dissimilarity metric values 110 includes calculating a log of the target entity's financial KPI value (e.g., such as a log of a median revenue for target entity 124 in the last 12 months) and a log of each entity's financial KPI value in the current set of entities, and then calculating an absolute difference between the log of the target entity's financial KPI value and the log of each entity's financial KPI value in the current set of entities.

In certain embodiments, where the entity characteristic 104 to be analyzed (e.g., selected at 106) is size entity characteristic 104(2), or more specifically number of employees, determining the dissimilarity metric values 110 includes calculating an absolute difference between the number of employees for target entity 124 (e.g., stored in datastore 102) and the number of employees for each entity in the current set of entities (e.g., also stored in datastore 102).

In certain embodiments, the entity characteristic 104 to be analyzed (e.g., selected at 106) is industry type entity characteristic 104(3). Industry types defined for target entity 124 and each entity in the current set of entities may include information about the type of product and/or service being offered by each entity. For example, target entity 124 may offer glass manufacturing services, and, as such, the industry type defined for target entity 124 in datastore 102 is “glass manufacturer.” Where the entity characteristic 104 to be analyzed is industry type entity characteristic 104(3), determining the dissimilarity metric values 110 may include (1) creating an embedding of the industry type for target entity 124 in a multidimensional space using a machine learning model, such as a bidirectional encoder representations from transformers (BERT) and (2) creating an embedding of the industry type for each entity in the current set of entities in the multidimensional space using BERT (in this example). Further, determining the dissimilarity metric values 110 includes (3) calculating a cosine distance between the embedding of the entity industry type for target entity 124 and the embedding of the industry type for each entity and (4) calculating the dissimilarity metric values 110 as one minus the cosine distance calculated for each target entity 124, entity pair (e.g., entity in the current set of entities) (1-cosine distance). Embedding sizes of different industry types may be similar in length, and the cosine distance is a measure of similarity. Thus, (1-cosine distance) is the measure of how similar or dissimilar two entities are, where a greater value calculated indicates less similarity in industry type between the two entities as opposed to a lesser value calculated.

In certain embodiments, the industry type indicated for target entity 124 and each entity in the current set of entities, in datastore 102, is based on user input. In certain embodiments, the industry type indicated for target entity 124 and each entity in the current set of entities, in datastore 102, is based on a known mapping of entities and their assigned industry types. For example, the mapping may be a D-U-N-S® mapping of entities and their assigned industry types made commercially available by Dun and Bradstreet, Inc.™ of Jacksonville, Florida. Other examples include industry types provided by NAICS and/or the SIC code. In certain embodiments, the industry type indicated for target entity 124 and each entity in the current set of entities, in datastore 102, is determined using a multiple linear regression model configured to predict entity industry types. The industry type indicated in datastore 102 for such entities may be updated each time the multiple linear regression model is used to output entity industry type predictions.

It should be noted that the above-described entity characteristics 104 and their associated methods for determining dissimilarity metric values 110 are only examples, and other characteristics and methods of measuring dissimilarity between characteristics are possible. For example, in some cases, a user may provide additional logic for calculating the dissimilarity metric values 110 for different entity characteristics 104 to customize the calculations being performed when determining the peer group for the target entity 124 (e.g., illustrated as the dotted line from user input 121 in FIG. 1).

For this example, because the first entity characteristic 104 selected, at 106, is location entity characteristic 104(1), the dissimilarity metric values 110 are calculated as a Haversine distance between the location for target entity 124 (e.g., stored in datastore 102) and the location for each entity in the current set of entities (e.g., also stored in datastore 102).

At 112, system 100 creates different subsets of entities from the current set of entities, for example, based on the selected entity characteristic 104. Further, at 112, system 100 (1) creates a distribution 130 for a set (S) of entities including all entities in the current set of entities and (2) creates distributions 130 for each of the determined subsets (e.g., SS1 and SS2) using their calculated dissimilarity metric values 110.

For example, the current set of entities may include six entities, as illustrated in FIG. 1. Two of the six entities have their headquarters located in San Diego, California (associated with postal code 92101), two of the six entities have their headquarters located in Austin, Texas (associated with postal code 78744), and the remaining two entities have their headquarters located in Houston, Texas (associated with postal code 77008). Target entity 124 has its headquarters located in Austin, Texas (associated with postal code 78712). Using the locations/postal codes of the different entities, system 100 determines to (1) create a set (S) including the six entities (e.g., a set having a total of six entities) and additionally (2) create two subsets (e.g., SS1 and SS2). The first subset (SS1) includes all the entities in the set (S) of entities, excluding the two entities with headquarters located in San Diego, California (e.g., total of four entities). The second subset (SS2) includes all the entities in the set (S) of entities, excluding the two entities with headquarters located in San Diego, California and the two entities with headquarters in Houston, Texas (e.g., total of two entities). Dissimilarity metric values 110 calculated for entities in the second subset (SS2) may indicate a greater “closeness” to target entity 124 with respect to location entity characteristic 104(1) than dissimilarity metric value 110 calculated for entities in first subset (SS1) (e.g., because entities in SS2 only include entities in Austin, Texas, where target entity 124 is located, as opposed to both Austin, TX and Houston, TX located entities) System 100 creates a distribution of dissimilarity metric values 110 for each of the identified subsets (e.g., SS1 and SS2) using the dissimilarity metric values 110 calculated for each subset entity, target entity 124 pair in each subset (not shown by the example in FIG. 1). Distribution 130 created for the set including all six entities is referred to herein as the “wide distribution,” while distributions 132 created for the subsets (e.g., SS1 and SS2) are referred to herein as “narrow distributions.”

Lastly, at 112, system 100 determines a benchmark score 134 for each of the identified subsets (e.g., SS1 and SS2). As described above, a benchmark score is calculated for a subset as the negative log of a p-value of a statistical hypothesis testing whether the distribution created for the subset is the same as the wide distribution (e.g., associated with the set, S, including the six entities). A negative log is taken of the p-value to help make the value calculated for benchmark score 134 positive and linear, given the p-value can be very close to zero.

For example, a set of entities, S, may include six current entities, such that S={E1, E2, . . . . E6}. A first subset A of the set of entities, S, includes two entities, such that A={E5, E6}. A second subset B of the set of entities, includes all current entities, such that B=S={E1, E2, . . . . E6}. The benchmark score 134, (BS(A, B)), is calculated as the negative log of the p-value of a statistical hypothesis testing whether a null hypothesis, H₀, or an alternative hypothesis, Ha, is correct. In this case, the null hypothesis is H₀:T(Y|A)=T(Y|B), while the alternative hypothesis is H_{α}:T(Y|A)≠T(Y|B), for any statistic T(.). The statistic of interest may be an expectation, quantiles, and/or the like. The benchmark score 134, (BS(A, B)), is higher where the distributional difference of Y between the two subsets A and B, is higher after taking into account natural variation. If the statistic of interest is selected to be an expectation, then under the assumption of normality, or in cases where there are statistically large samples, a two sample student's t-test may be used to compute the benchmark score. The two-sample student's t-test is a method used to test whether the unknown population means of two groups are equal or not. In certain embodiments, for more complicated statistics, a small sample bootstrap test may be used.

For example, a benchmark score 134, BS, calculated for a subset using a two-sample student's t-test is:

$$BS = - log ( 2 * P ( T > \vert {T}_{obs} \vert \vert {H}_{o} is true ) )$$

where Hₒ is the null hypothesis, and the null hypothesis is:

$${H}_{o} : {μ}_{subset} = {μ}_{trivial subset}$$

where μ_{subset} is a distribution of dissimilarity metric values 110 associated with a particular entity characteristic (e.g., where the particular entity characteristic is a KPI value) and measured between a target entity 124 and each entity in the subset (e.g., for which benchmark score 134 is being calculated). Variable μ_{trivial subset} is a distribution of dissimilarity metric values 110 associated with the particular entity characteristic (e.g., KPI value) and measured between the target entity 124 and each entity in a trivial subset of entities including all entities in a current set of entities. When the null hypothesis test is determined not to be true, an alternative hypothesis, H_{α}, is true. In this case, the alternative hypothesis, H_{α}, is:

$${H}_{α} : {μ}_{subset} \neq {μ}_{trivial subset}$$

Further, for the benchmark score 134, BS, calculation, P refers to the probability, T refers to the student's t-distribution, and T_{obs} is provided by the below equation:

$${T}_{obs} = \frac{( {\overline{X}}_{subset} - {\overline{X}}_{trivial subset} )}{( se ( {\overline{X}}_{subset} - {\overline{X}}_{trivial subset} ) )}$$

where X̅_{subset} is equal to the mean of entity characteristic values (e.g., mean of KPI values) for the subset, X̅_{trivial subset} is equal to the mean of entity characteristic values (e.g., mean of KPI values) for the trivial subset (e.g., including all entities), and se refers to the standard error.

At 114, system 100 identifies a subset of entities that provides the most significant (e.g., least trivial) and confident distributional difference between the identified subset of entities and all other subsets of entities. In other words, at 114, system 100 identifies a subset of entities having a highest calculated benchmark score 134 for the selected entity characteristic 104. Further, at 114, system 100 resets the current entities 116 to include only the identified subset of entities having the highest benchmark score.

In this example, the first subset (SS1) has the highest benchmark score. As such, at 114, system 100 resets the current entities 116 to be the first subset of entities.

At 118, system 100 determines whether all entity characteristics 104 have been considered. If system 100 determines that not all entity characteristics 104 have been considered, then system 100 selects a new entity characteristic 104, at 106. The new entity characteristic 104 selected in an entity characteristic 104 from the set of entity characteristics 105 that has not been previously selected. The new entity characteristic 140 may be selected at random from the set of entity characteristics 105 excluding any previously selected entity characteristics 104, based on user input, etc.

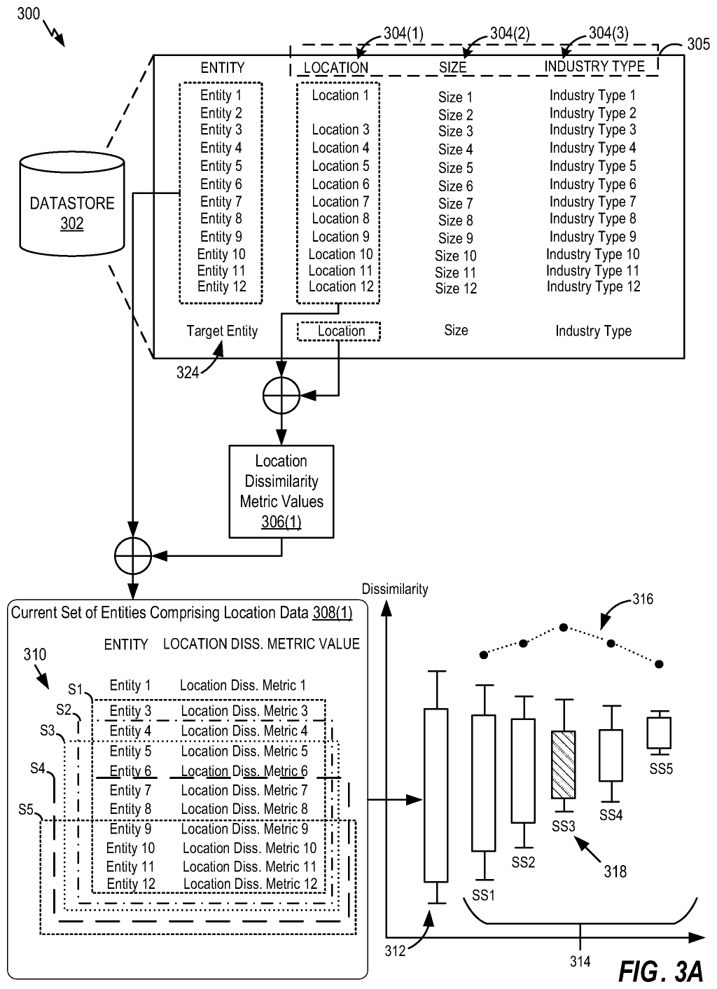

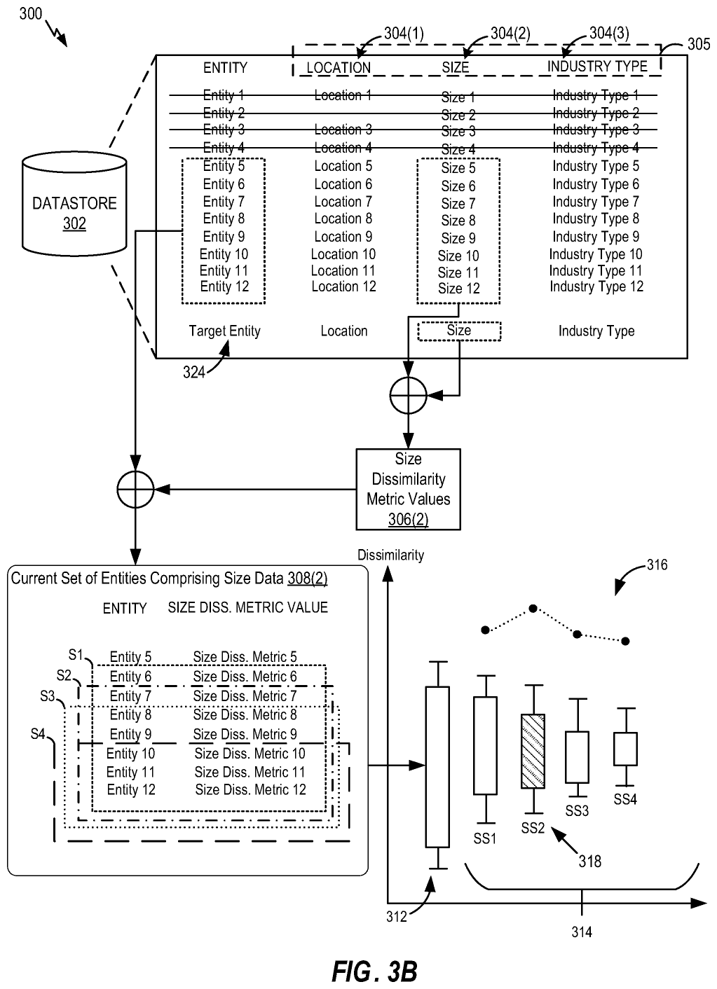

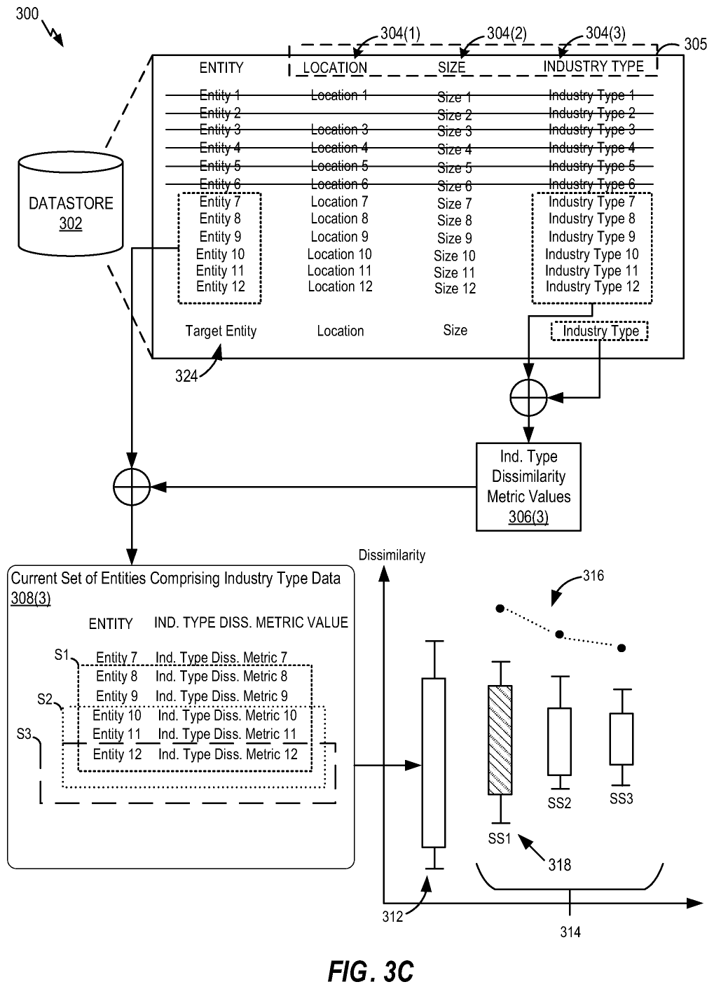

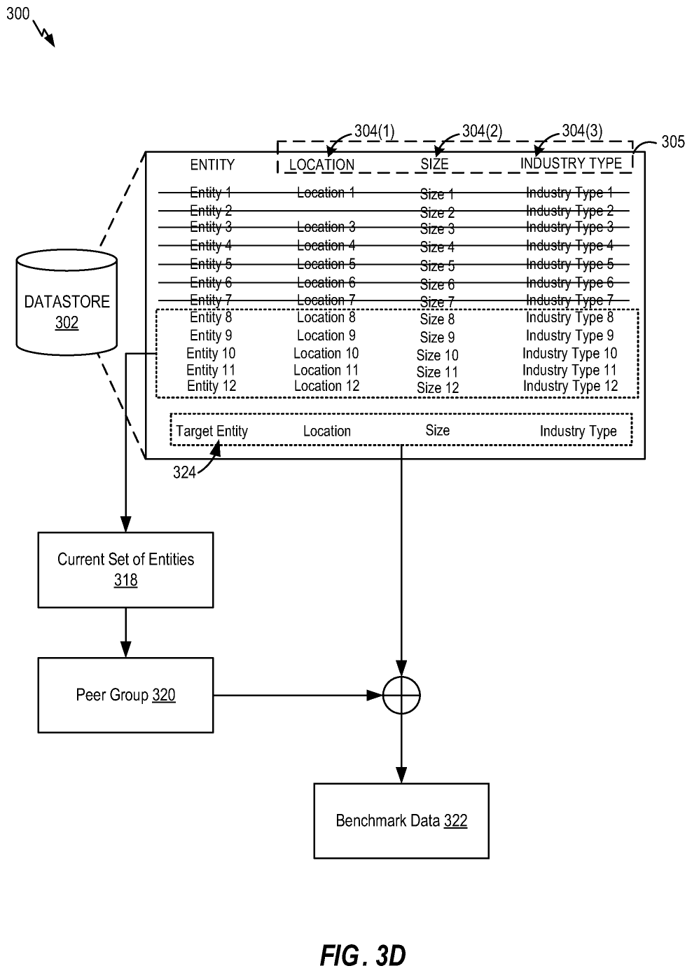

System 100 then repeats the steps described above, iteratively for each characteristic, e.g., including determining dissimilarity metric values, determining subsets of entities, creating distributions for each of the subsets of entities, calculating benchmark scores for the subsets, and identifying a subset having a highest benchmark score for each characteristic. However, instead of performing these steps for all entities identified in datastore 102, the steps are performed only for entities in the current entities 116 reset at 114. For this example, the steps are performed again for a new entity characteristic 104 and for only the four entities with headquarters in Houston, Texas and Austin, Texas. As such, each iteration performed for a new entity characteristic 104 may result in a smaller subset of entities being identified as the subset with the highest benchmark score (e.g., illustrated in more detail in FIGS. 3A-3D).

After all entity characteristics 104 have been considered, at 120, the peer group for target entity 124 is identified as the current set of entities reset at 114, or in other words, the last subset identified with a highest benchmark score 134. At 122, data for entities in this peer group is compared to target entity 124's data to determine benchmark data for target entity 124. In certain embodiments, this benchmark data is provided to a user via a user interface.

In certain embodiments, entity characteristics are analyzed in an order (e.g., selected in an order at 106) based on benchmark scores calculated for each entity characteristic 104. In particular, distributions 132 for multiple subsets of entities (e.g., created from the current set of entities stored in datastore 102) may be created for each entity characteristic 104. A benchmark score 134 is calculated for each of these subsets based on each subset's corresponding distribution. A subset with a highest benchmark score 134 may be determined for each entity characteristic 104. The highest benchmark score 134 is then associated with the respective entity characteristic 104. An entity characteristic 104 associated with a highest benchmark score 134 among benchmark scores 134 for other entity characteristics 104 may be selected as the first entity characteristic 104, at 106. A next analyzed entity characteristic (e.g., selected at 106) may be an entity characteristic associated with a next highest benchmark score 134.

### Example Method of Benchmarking a Target Entity

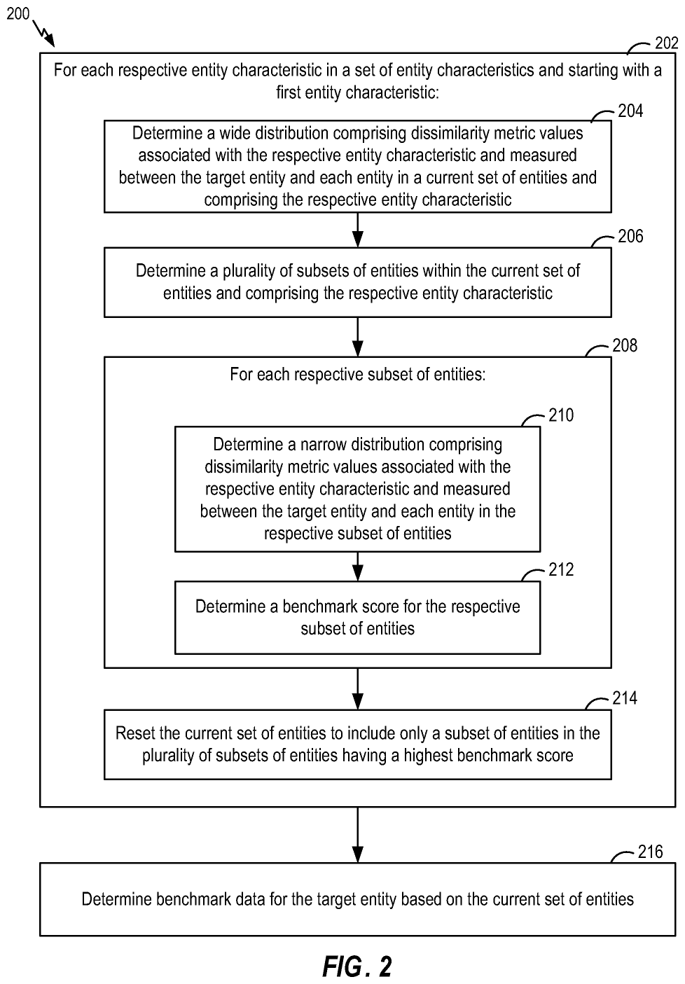

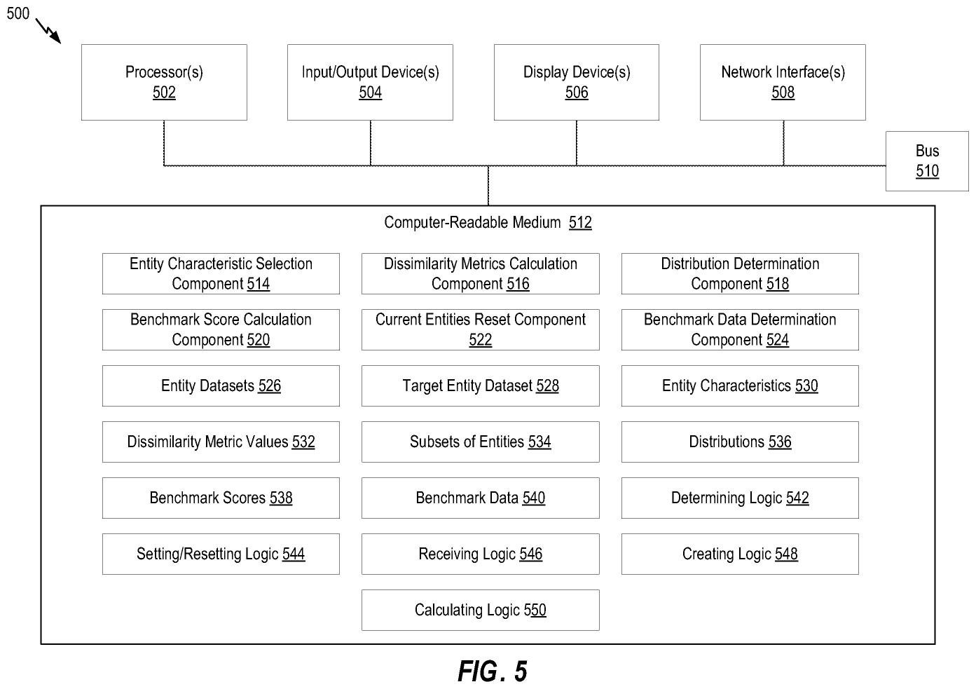

FIG. 2 illustrates an example method 200 of benchmarking a target entity. Method 200 illustrates benchmarking the target entity by analyzing a set of entity characteristics associated with the target entity and each entity in a current set of entities to determine a peer group for the target entity. Data for the peer group is then used to determine benchmark data for the target entity. Method 200 may be performed by one or more processor(s) of a computing device, such as processor(s) 502 of processing system 500 described below with respect FIG. 5.

FIGS. 3A-3D illustrate example peer group determination 300 for generating benchmark data for a target entity, based on example method 200 illustrated in FIG. 2. FIGS. 2 and 3A-3D are described in conjunction below.

As described above, method 200 benchmarks a target entity by first analyzing a set of entity characteristics associated with the target entity and each entity in a current set of entities. Thus, method 200 begins, at step 202, by determining an entity characteristic, such as a first entity characteristic, to use for performing steps 204-214 illustrated in FIG. 2 (e.g., “for each respective entity characteristic in a set of entity characteristics and starting with a first entity characteristic”).

For example, in FIG. 3A, datastore 302 stores data about twelve entities and a target entity 324. This data includes values for a location entity characteristic 304(1), a size entity characteristic 304(2), and/or an industry type entity characteristic 304(3) for each entity in datastore 302 (e.g., collectively referred to herein as entity characteristics 304 in a set of entity characteristics 305). In some cases, values for location entity characteristic 304(1), size entity characteristic 304(2), and/or industry type entity characteristic 304(3) are missing for one or more of the entities. Where provided, a location entity characteristic 304(1) value identifies a postal code for the respective entity, a size entity characteristic 304(2) value indicates a number of employees for the respective entity, and an industry type entity characteristic 304(3) value indicates a type of product and/or service being offered by the respective entity. For illustration, only a location entity characteristic 304(1) value is missing for the second entity (e.g., Entity 2).

In this example, benchmarking is to be performed for target entity 324. Thus, at step 202 in FIG. 2, a first entity characteristic 304 is selected as location entity characteristic 304(1).

Method 200 proceeds, at step 204, with determining a wide distribution comprising dissimilarity metric values associated with the respective entity characteristic (entity location in this example) and measured between the target entity and each entity in a current set of entities and comprising the respective entity characteristic (e.g., determined at step 202).

For example, in FIG. 3A, the current set of entities includes Entities 1-12. Entities in the current set of entities and comprising location data 308(1) (e.g., values for location entity characteristic 304(1)) include Entity 1 and Entities 3-12 (e.g., excluding Entity 2) (as shown at 310). Location dissimilarity metric values 306(1) are measured between target entity 324 and the eleven entities (e.g., Entity 1 and Entities 3-12). In particular, a first location dissimilarity metric value 306(1) (e.g., “Location Dissimilarity Metric 1”) is determined using the location data for Entity 1 and the location data for target entity 324. Ten other location dissimilarity metric values 306(1) are determined using the location data for target entity 324 and location data for each of Entities 3-12. The location dissimilarity metric values 306(1) may be calculated as a Haversine distance. A wide distribution 312 is determined using the location dissimilarity metric values 306 measured between target entity 324 and each of the eleven entities (e.g., Location Dissimilarity Metric 1 and Location Dissimilarity Metrics 3-12).

Method 200 then proceeds, at step 206, with determining a plurality of subsets of entities within the current set of entities and comprising the respective entity characteristic. The plurality of subsets of entities may be determined based on the respective entity characteristic (e.g., determined at step 202). For example, the plurality of subsets of entities may be determined based on non-overlapping values for the respective entity characteristic associated with the different entities in the current set of entities and/or ranges of values for the respective entity characteristic associated with the different entities in the current set of entities.

As another example, entities belonging to each of the subsets of entities may be determined based on a cut-off value assigned to each subset. The cut-off value assigned to each subset is based on values for the respective entity characteristic associated with the different entities in the current set of entities. A current set of entities may include entities having locations (e.g., values for location entity characteristic 304(1)) that are an (X) distance from the location of target entity 324, entities having locations that are an (X+Y) distance from the location of target entity 324, and entities having locations that are an (X+Y+Z) distance from the location of target entity 324, where X, Y, and Z are any positive value. As such, a cut-off value assigned to a first subset may be equal to X, such that the subset includes all entities with locations a distance from target entity 324 less than X. A cut-off value assigned to a second subset may be equal to (X+Y), such that the subset includes all entities with locations a distance from target entity 324 less than (X+Y). Further, a cut-off value assigned to a third subset may be equal to (X+Y+Z), such that the subset includes all entities with locations a distance from target entity 324 less than (X+Y+Z).

In FIG. 3A, five subsets (e.g., SS1, SS2, . . . . SS5) are created for the current set of entities comprising location data 308(1) (e.g., created for Entity 1 and Entities 3-12). As illustrated, the first subset, SS1, includes all entities in the current set of entities except Entity 1. The second subset, SS2, includes all entities in SS1 except for Entity 3. The third subset, SS3, includes all entities in SS2 except for Entity 4. The fourth subset, SS4, includes all entities in SS3 except for Entity 5 and Entity 6. The fifth subset, SS5, includes all entities in SS4 except Entity 7 and Entity 8.

SS5 includes entities most closely related to target entity 324 when only location of the entities is considered (e.g., having a small Haversine distance). SS4 includes entities more closely related to target entity 324 than SS3, SS2, and SS1 when only location of the entities is considered, SS3 includes entities more closely related to target entity 324 than SS2 and SS1 when only location of the entities is considered, and so forth. For example, SS1 may include entities that are within a 200 mile radius from the location of target entity 324, SS2 may include entities that are within a 150 mile radius from the location of target entity 324, SS3 may include entities that are within a 100 mile radius from the location of target entity 324, SS4 may include entities that are within a 50 mile radius from the location of target entity 324, and SS5 may include entities that are within a 25 mile radius from the location of target entity 324.

Method 200 then proceeds, at step 208, with performing steps 210 and 212 for each respective subset of entities. Method 200 proceeds, at step 210, with determining a narrow distribution comprising dissimilarity metric values associated with the respective entity characteristic and measured between the target entity and each entity in the respective subset of entities. Further method 200 proceeds, at step 212, with determining a benchmark score for the respective subset of entities. In certain embodiments, the benchmark score is determined by comparing the distribution for the respective subset of entities with the wide distribution associated with the current set of entities (e.g., determined at step 204). For example, step 212 may involve comparing KPI distributions for the respective subset of entities and the current set of entities.

In FIG. 3A, steps 210 and 212 are performed for each of subsets SS1-SS5 (e.g., five iterations). Beginning with SS1, a first narrow distribution 314 (e.g., labeled as SS1 in the boxplot in FIG. 3A) is determined using the location dissimilarity metric values 306(1) measured between target entity 324 and each of the Entities 3-12 (e.g., Location Dissimilarity Metrics 3-12). For SS2, a second narrow distribution 314 (e.g., labeled as SS2 in the boxplot in FIG. 3A) is determined using the location dissimilarity metric values 306(1) measured between target entity 324 and each of the Entities 4-12 (e.g., Location Dissimilarity Metrics 4-12). Similarly, a third, fourth, and fifth narrow distribution 314 are determined for SS3, SS4, and SS5, respectively. A benchmark score 316 is then calculated for each of subsets SS1-SS5. The determined benchmark scores 316 are illustrated as the plotted dots in the distribution graph in FIG. 3A. A subset having a lowest benchmark score is a subset in the distribution graph with a smallest y-axis value, while a subset having a highest benchmark score is a subset in the distribution graph with a largest y-axis value.

Method 200 then proceeds, at step 214, with resetting the current set of entities to include only the subset of entities in the plurality of subsets of entities having a highest benchmark score (as determined at step 212). For example, in FIG. 3A, the current set of entities includes Entities 1-12. The subset of entities having the highest benchmark score is subset SS3 (e.g., 318 in FIG. 3A), which includes Entities 5-12. At step 214, the current set of entities is reset to include only Entities 5-12 (e.g., a total of eight entities) instead of Entities 1-12 (e.g., a total of twelve entities).

Method 200 then proceeds with iteratively performing steps 204-214, described above, for each additional entity characteristic that is to be considered. Iteratively performing steps 204-214 for each entity characteristic further limits the current set of entities. Steps 204-214 may be re-performed until all entity characteristics that are to be considered have been considered.

In FIGS. 3A-3D, three entity characteristics 304 are defined for each of the entities in datastore 302, including location entity characteristic 304(1), size entity characteristic 304(2), and industry type entity characteristic 304(3). Location entity characteristic 304(1) is analyzed first, as illustrated in FIG. 3A. In particular, steps 204-214 in FIG. 2 are performed for location entity characteristic 304(1). Next, steps 204-214 in FIG. 2 are performed for size entity characteristic 304(2), as illustrated in FIG. 3B.

As previously discussed, the current set of entities has been reset to include only Entities 5-12. Entities in the current set of entities and comprising size data 308(2) (e.g., values for size entity characteristic 304(2) in datastore 302) include all entities in the current set of entities (e.g., Entities 5-12) given none of these entities are missing size data in datastore 302. Size dissimilarity metric values 306(2) are measured between target entity 324 and Entities 5-12. A wide distribution 312 is determined using the size dissimilarity metric values 306(2) measured between target entity 324 and each of Entities 5-12 (e.g., Location Dissimilarity Metrics 5-12).

As illustrated in FIG. 3B, four subsets (e.g., SS1, SS2, . . . . SS4) are created for the current set of entities comprising values for size entity characteristic 304(2) (e.g., created for Entities 5-12). As illustrated, the first subset, SS1, includes all entities except Entity 5. The second subset, SS2, includes all entities in SS1 except for Entity 6. The third subset, SS3, includes all entities in SS2 except for Entity 7. The fourth subset, SS4, includes all entities in SS3 except for Entity 8 and Entity 9.

For this example, SS1-SS4 may include only entities within a 100 mile radius from the location of target entity 324. In particular, because in FIG. 3A, the current entities were reset to include only entities in previously-created subset, SS3 in FIG. 3A, and SS3 included only entities within a 100 mile radius from the location of target entity 324, each of the subsets created in FIG. 3B include only entities within the 100 mile radius. Subsets, SS1-SS4 in FIG. 3B, create different subsets of entities among entities within the 100 mile radius. For example, target entity 324 may have 3,800 employees. SS1 may include entities that are within the 100 mile radius and have 10,000 employees or less. SS2 may include entities that are within the 100 mile radius and have 8,000 employees or less. SS3 may include entities that are within the 100 mile radius and have 6,000 employees or less. Lastly, SS4 may include entities that are within the 100 mile radius and have 4,000 employees or less.

Narrow distributions 314 are determined for each of subsets SS1-SS4 using the size dissimilarity metric values 306(2) measured between target entity 324 and each of the entities belonging to each subset SS1-SS4. A benchmark score 316 is then calculated for each of subsets SS1-SS4. The determined benchmark scores 316 are illustrated as the plotted dots in the boxplot in FIG. 3B.

In FIG. 3B, the subset of entities having the highest benchmark score is subset SS2 (e.g., 318 in FIG. 3B), which includes Entities 7-12. Accordingly, the current set of entities is reset to include only Entities 7-12 (e.g., a total of six entities) instead of Entities 5-12 (e.g., a total of eight entities).

Method 200 then again proceeds with re-performing steps 204-214, described above, for the last entity characteristic 304 (e.g., industry type entity characteristic 304(3)). Steps 204-214 in FIG. 2 are performed for industry type entity characteristic 304(3), as illustrated in FIG. 3C.

As previously discussed, the current set of entities has been reset to include only Entities 7-12. Entities in the current set of entities and comprising industry type data 308(3) (e.g., values for industry type entity characteristic 304(3)) include all entities in the current set of entities (e.g., Entities 7-12) given none of these entities are missing industry type data in datastore 302. Industry type dissimilarity metric values 306(3) are measured between target entity 324 and Entities 7-12. A wide distribution 312 is determined using the industry type dissimilarity metric values 306(3) measured between target entity 324 and each of Entities 7-12 (e.g., Location Dissimilarity Metrics 7-12).

As illustrated in FIG. 3C, three subsets (e.g., SS1, SS2, SS3) are created for the current set of entities comprising industry type data 308(3) (e.g., created for Entities 7-12). As illustrated, the first subset, SS1, includes all entities except Entity 7. The second subset, SS2, includes all entities in SS1 except for Entity 8 and Entity 9. The third subset, SS3, includes all entities in SS2 except for Entity 10 and Entity 11.

For this example, SS1-SS3 may include only entities within a 100 mile radius from the location of target entity 324 and have 8,000 employees or less. In particular, because in FIG. 3B, the current entities were reset to include only entities in previously-created subset SS2, and SS2 included only entities within a 100 mile radius from the location of target entity 324 and having 8,000 employees or less, each of the subsets created in FIG. 3C include only entities within the 100 mile radius and that have 8,000 employees or less. Subsets, SS1-SS3 in FIG. 3C, create different subsets of entities among entities within the 100 mile radius and having 8,000 employees or less. For example, SS1 includes entities that are within the 100 mile radius, have 8,000 employees or less, and are associated with the automobile industry. SS2 includes entities that are within the 100 mile radius, have 8,000 employees or less, are associated with the automobile industry, and more specifically, perform automobile maintenance. SS3 may include entities that are within the 100 mile radius, have 8,000 employees or less, are associated with the automobile industry, perform automobile maintenance, and more specifically, only perform automobile maintenance for luxury, high-performance vehicles. In this example, target entity 324 is within the automobile industry, performs automobile maintenance for luxury, high-performance vehicles, and more specifically, performs automobile maintenance for only vehicles made commercially available by Automobili Lamborghini S.p.A. (e.g., Lamborghini®).

Narrow distributions 314 are determined for each of subsets SS1-SS3 using the industry type dissimilarity metric values 306(3) measured between target entity 324 and each of the entities belonging to each subset SS1-SS3. A benchmark score 316 is then calculated for each of subsets SS1-SS3. The determined benchmark scores 316 are illustrated as the plotted dots in the boxplot in FIG. 3C.

In FIG. 3C, the subset of entities having the highest benchmark score 316 is subset SS1 (e.g., 318 in FIG. 3C), which includes Entities 8-12. Accordingly, the current set of entities is reset to include only Entities 8-12 (e.g., a total of five entities). More specifically, the current set of entities is reset to include only entities within a 100 mile radius of target entity 324, which have 8,000 employees or less, and are associated with the automobile industry.

Returning to FIG. 2, after steps 204-214 are performed for each entity characteristic in the set of entity characteristics, method 200 proceeds, to step 216, with determining benchmark data for the target entity based on the current set of entities. The current set of entities is determined to be the peer group for the target entity. Accordingly, target entity 124's data may be compare to data of entities (e.g., its peers) that make up the peer group to generate benchmark data for the target entity 124.

For example, in FIG. 3D, the current set of entities 318, including Entities 8-12, is determined to be the peer group 320 for target entity 324. In other words, the peer group includes entities within a 100 mile radius of target entity 324, which have 8,000 employees or less, and are associated with the automobile industry (e.g., also including target entity 324). Data for Entities 8-12 in peer group 320 is then compared with data for target entity 324 to generate benchmark data 322. Benchmark data 322 may identify how target entity 324 performs with respect to its industry peers, Entities 8-12. Benchmark data 322 may beneficially aid target entity 324 (e.g., a user associated with target entity 324) in making strategic decisions, business planning, identifying areas for improvement, and/or the like.

### Example Benchmark Data

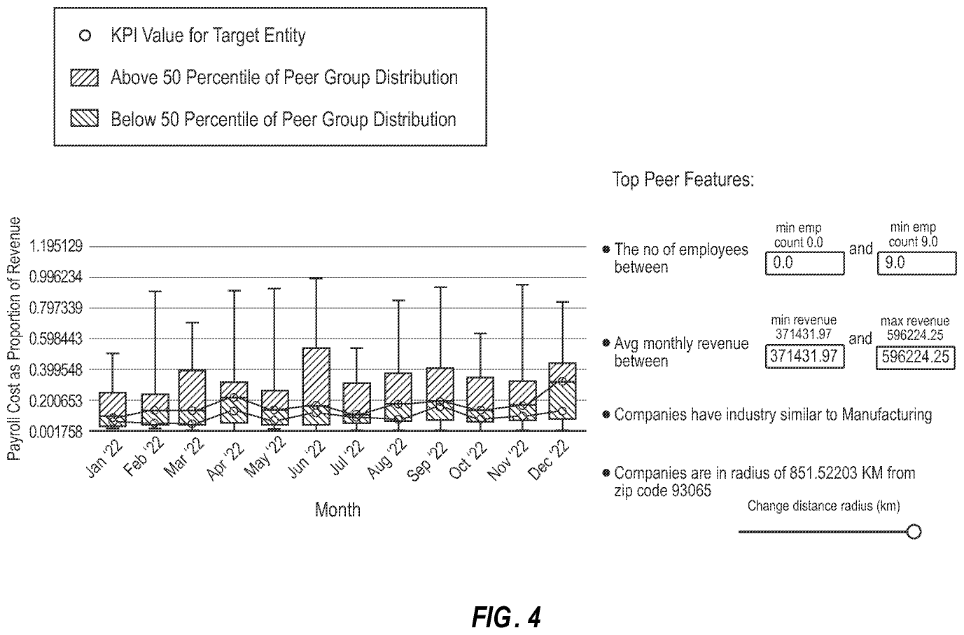

FIG. 4 illustrates example benchmark data generated for a target entity (e.g., benchmark data 322 for target entity 324 in FIG. 3D). As illustrated, the example benchmark data generated for the target entity may be provided via a user interface (UI) in the form of a boxplot. However, other methods of displaying the example benchmark data may also be considered.

In this example UI, a user selects to view payroll cost as a proportion of revenue for the target entity compared to other entities in its determined peer group (e.g., determined using method 200 as described above with respect to FIG. 2 and the example described with respect to FIGS. 3A-3D). The peer group for the target entity includes entities (1) having a number of employees between, and including, zero and nine employees, (2) having an average monthly revenue between $37,143.97 and $596,224.25, (3) having an industry type similar to Manufacturing, and (4) within a radius of 851.52203 kilometers (KM) from zip code 93065 (e.g., the zip code of the target entity).

The boxplot generated with example benchmark data illustrates how the target entity's payroll cost as a proportion of revenue per month compares to the peer entities' payroll cost as a proportion of revenue per month. The boxplot is created to display data over a previous twelve month period, in this case, between January 2022 and December 2022.

### Example Processing System for Benchmarking a Target Entity

FIG. 5 depicts an example processing system 500 configured to perform various aspects described herein, including, for example, method 200 as described above with respect to FIG. 2 and the example described with respect to FIGS. 3A-3D.

Processing system 500 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 500 includes one or more processors 502, one or more input/output devices 504, one or more display devices 506, and one or more network interfaces 508 through which processing system 500 is connected to one or more networks (e.g., a local network, an intranet, the Internet, or any other group of processing systems communicatively connected to each other), and computer-readable medium 512.

In the depicted example, the aforementioned components are coupled by a bus 510, which may generally be configured for data and/or power exchange amongst the components. Bus 510 may be representative of multiple buses, while only one is depicted for simplicity.

Processor(s) 502 are generally configured to retrieve and execute instructions stored in one or more memories, including local memories like the computer-readable medium 512, as well as remote memories and data stores. Similarly, processor(s) 502 are configured to retrieve and store application data residing in local memories like the computer-readable medium 512, as well as remote memories and data stores. More generally, bus 510 is configured to transmit programming instructions and application data among the processor(s) 502, display device(s) 506, network interface(s) 508, and computer-readable medium 512. In certain embodiments, processor(s) 502 are included to be representative of a one or more central processing units (CPUs), graphics processing unit (GPUs), tensor processing unit (TPUs), accelerators, and other processing devices.

Input/output device(s) 504 may include any device, mechanism, system, interactive display, and/or various other hardware components for communicating information between processing system 500 and a user of processing system 500. For example, input/output device(s) 504 may include input hardware, such as a keyboard, touch screen, button, microphone, and/or other device for receiving inputs from the user. Input/output device(s) 504 may further include display hardware, such as, for example, a monitor, a video card, and/or other another device for sending and/or presenting visual data to the user. In certain embodiments, input/output device(s) 504 is or includes a graphical user interface.

Display device(s) 506 may generally include any sort of device configured to display data, information, graphics, user interface elements, and the like to a user. For example, display device(s) 506 may include internal and external displays such as an internal display of a tablet computer or an external display for a server computer or a projector. Display device(s) 506 may further include displays for devices, such as augmented, virtual, and/or extended reality devices.

Network interface(s) 508 provide processing system 500 with access to external networks and thereby to external processing systems. Network interface(s) 508 can generally be any device capable of transmitting and/or receiving data via a wired or wireless network connection. Accordingly, network interface(s) 508 can include a communication transceiver for sending and/or receiving any wired and/or wireless communication. For example, Network interface(s) 508 may include an antenna, a modem, a LAN port, a Wi-Fi card, a WiMAX card, cellular communications hardware, near-field communication (NFC) hardware, satellite communication hardware, and/or any wired or wireless hardware for communicating with other networks and/or devices/systems. In certain embodiments, network interface(s) 508 includes hardware configured to operate in accordance with the Bluetooth® wireless communication protocol.

Computer-readable medium 512 may be a volatile memory, such as a random access memory (RAM), or a nonvolatile memory, such as nonvolatile random access memory, phase change random access memory, or the like. In this example, computer-readable medium 512 includes entity characteristic selection component 514, dissimilarity metrics calculation component 516, distribution determination component 518, benchmark score calculation component 520, current entities reset component 522, benchmark data determination component 524, entity datasets 526, target entity dataset 528, entity characteristics 530, dissimilarity metric 532, subsets of entities 534, distribution 536, benchmark scores 538, benchmark data 540, determining logic 542, setting/resetting logic 544, receiving logic 546, creating logic 548, and calculating logic 550.

In certain embodiments, entity characteristic selection component 514 is configured to select different entity characteristics for analysis.

In certain embodiments, dissimilarity metrics calculation component 516 is configured to determine dissimilarity metric values associated with a respective entity characteristic and measured between a target entity and each entity in a current set of entities and comprising the respective entity characteristic.

In certain embodiments, distribution determination component 518 is configured to determine a wide distribution comprising dissimilarity metric values associated with a respective entity characteristic and measured between a target entity and each entity in a current set of entities and comprising the respective entity characteristic. In certain embodiments, distribution determination component 518 is configured to determine a narrow distribution comprising dissimilarity metric values associated with a respective entity characteristic and measured between a target entity and each entity in a respective subset of entities.

In certain embodiments, benchmark score calculation component 520 is configured to determine a benchmark score for each subset of entities.

In certain embodiments, current entities reset component 522 is configured to identify a subset of entities that provides a most significant (e.g., least trivial) and confident distributional difference between the identified subset of entities and all other subsets of entities (e.g., identify a subset having a highest benchmark score). Further, current entities reset component 522 is configured to reset current entities to the identified subset of entities that provide the most significant (e.g., least trivial) and confident distributional difference (e.g., having the highest benchmark score).

In certain embodiments, benchmark data determination component 524 is configured to determine benchmark data for a target entity.

In certain embodiments, entity datasets 526 include one or more entities and data about each of these one or more entities. The data may include information about each entity's entity characteristics.

In certain embodiments, target entity dataset 528 includes a single entity and data about the single entity. The data may include information about the entity's entity characteristics

In certain embodiments, entity characteristics 530 include features associated with different entities that are analyzed to form different peer groups.

In certain embodiments, dissimilarity metric values define the “closeness” between any two given entities with respect to a particular entity characteristic.

In certain embodiments, subsets of entities 534 include grouping of entities from a current set of entities, where entities in each subset share at least one similar characteristic.

In certain embodiments, distributions 536 are distributions comprising dissimilarity metric values associated with a respective entity characteristic and measured between a target entity and each entity in a set or subset of entities and comprising the respective entity characteristic. Distributions 536 may include wide distributions and/or narrow distributions.

In certain embodiments, benchmark scores 538 are scores calculated for subsets of entities. In certain embodiments, benchmark scores 538 are calculated as the negative log of a p-value of a statistical hypothesis testing whether the narrow distribution associated with a set or subset of entities is the same as a wide distribution associated with the a subset including all candidate peer group entities

In certain embodiments, benchmark data 540 includes data generated for a target entity by comparing data for industry peers to data of the target entity (e.g., where the industry peers and the target entity belong to a same peer group).

In certain embodiments, determining logic 542 includes logic for determining a wide distribution comprising dissimilarity metric values associated with the respective entity characteristic and measured between the target entity and each entity in a current set of entities and comprising the respective entity characteristic. In certain embodiments, determining logic 542 includes logic for determining a plurality of subsets of entities within the current set of entities and comprising the respective entity characteristic. In certain embodiments, determining logic 542 includes logic for determining a narrow distribution comprising dissimilarity metric values associated with the respective entity characteristic and measured between the target entity and each entity in the respective subset of entities. In certain embodiments, determining logic 542 includes logic for determining a benchmark score for the respective subset of entities. In certain embodiments, determining logic 542 includes logic for determining benchmark data for the target entity based on the current set of entities. In certain embodiments, determining logic 542 includes logic for determining a weighting for each respective entity characteristic of the set of entity characteristics. In certain embodiments, determining logic 542 includes logic for determining the benchmark data for the target entity further based on the weighting for each respective entity characteristic of the set of entity characteristics. In certain embodiments, determining logic 542 includes logic for determining a negative log of a p-value of a statistical hypothesis testing whether a narrow distribution associated with the respective subset of entities is the same as the wide distribution associated with the current set of entities. In certain embodiments, determining logic 542 includes logic for determining the dissimilarity metric values associated with the respective entity characteristic and measured between the target entity and each entity in the current set of entities and comprising the respective entity characteristic.

In certain embodiments, setting/resetting logic 544 includes logic for resetting the current set of entities to include only a subset of entities in the plurality of subsets of entities having a highest benchmark score. In certain embodiments, setting/resetting logic 544 includes logic for setting as the first entity characteristic the entity characteristic of the set of entity characteristics associated with the highest benchmark score.

In certain embodiments, receiving logic 546 includes logic for receiving from a user the set of entity characteristics.

In certain embodiments, creating logic 548 includes logic for creating an embedding of the entity industry type for the target entity. In certain embodiments, creating logic 548 includes logic for creating an embedding of the entity industry type for each entity in the current set of entities and comprising the respective entity characteristic in a multidimensional space using bidirectional encoder representations from transformers (BERT).

In certain embodiments, calculating logic 550 includes logic for calculating a Haversine distance between the target entity and each entity in the current set of entities and comprising the respective entity characteristic. In certain embodiments, calculating logic 550 includes logic for calculating a cosine distance between the embedding of the entity industry type for the target entity and the embedding of the entity industry type for each entity. In certain embodiments, calculating logic 550 includes logic for calculating the dissimilarity metric values as one minus the cosine distance calculated between the embedding of the entity industry type for the target entity and the embedding of the entity industry type for each entity. In certain embodiments, calculating logic 550 includes logic for calculating an Euclidean distance between the financial feature over the period of time associated with the target entity and the financial feature over the period of time associated with each entity in the current set of entities and comprising the respective entity characteristic.

Note that FIG. 5 is just one example of a processing system consistent with aspects described herein, and other processing systems having additional, alternative, or fewer components are possible consistent with this disclosure.

### Example Clauses

Implementation examples are described in the following numbered clauses:

Clause 1: A method of benchmarking a target entity, comprising: for each respective entity characteristic in a set of entity characteristics and starting with a first entity characteristic: determining a wide distribution comprising dissimilarity metric values associated with the respective entity characteristic and measured between the target entity and each entity in a current set of entities and comprising the respective entity characteristic; determining a plurality of subsets of entities within the current set of entities and comprising the respective entity characteristic; for each respective subset of entities: determining a narrow distribution comprising dissimilarity metric values associated with the respective entity characteristic and measured between the target entity and each entity in the respective subset of entities; and determining a benchmark score for the respective subset of entities; resetting the current set of entities to include only a subset of entities in the plurality of subsets of entities having a highest benchmark score; and determining benchmark data for the target entity based on the current set of entities.

Clause 2: The method of Clause 1, further comprising setting as the first entity characteristic the entity characteristic of the set of entity characteristics associated with the highest benchmark score.

Clause 3: The method of any one of Clauses 1-2, wherein determining a benchmark score for the respective subset of entities comprises determining a negative log of a p-value of a statistical hypothesis testing whether a narrow distribution associated with the respective subset of entities is the same as the wide distribution associated with the current set of entities.

Clause 4: The method of any one of Clauses 1-3, further comprising receiving from a user the set of entity characteristics.

Clause 5: The method of any one of Clauses 1-4, further comprising: for each respective entity characteristic in the set of entity characteristics and starting with the first entity characteristic: determining the dissimilarity metric values associated with the respective entity characteristic and measured between the target entity and each entity in the current set of entities and comprising the respective entity characteristic.

Clause 6: The method of Clause 5, wherein: the respective entity characteristic comprises entity location; and determining the dissimilarity metric values associated with the respective entity characteristic and measured between the target entity and each entity in the current set of entities and comprising the respective entity characteristic comprises calculating a Haversine distance between the target entity and each entity in the current set of entities and comprising the respective entity characteristic.

Clause 7: The method of any one of Clauses 5-6, wherein: the respective entity characteristic comprises entity industry type; and determining the dissimilarity metric values associated with the respective entity characteristic and measured between the target entity and each entity in the current set of entities and comprising the respective entity characteristic comprises: creating an embedding of the entity industry type for the target entity in a multidimensional space using a machine learning model; creating an embedding of the entity industry type for each entity in the current set of entities and comprising the respective entity characteristic in the multidimensional space using the machine learning model; and calculating a cosine distance between the embedding of the entity industry type for the target entity and the embedding of the entity industry type for each entity; and calculating the dissimilarity metric values as one minus the cosine distance calculated between the embedding of the entity industry type for the target entity and the embedding of the entity industry type for each entity.

Clause 8: The method of any one of Clauses 5-7, wherein: the respective entity characteristic comprises a financial feature over a period of time; and determining the dissimilarity metric values associated with the respective entity characteristic and measured between the target entity and each entity in the current set of entities and comprising the respective entity characteristic comprises calculating an Euclidean distance between the financial feature over the period of time associated with the target entity and the financial feature over the period of time associated with each entity in the current set of entities and comprising the respective entity characteristic.

Clause 9: A method of benchmarking a target entity, comprising: for each respective entity characteristic in a set of entity characteristics: determining a first wide distribution comprising first dissimilarity metric values associated with the respective entity characteristic and measured between the target entity and each entity in a set of entities and comprising the respective entity characteristic; determining a plurality of first subsets of entities within the set of entities and comprising the respective entity characteristic; for each respective first subset of entities: determining a first narrow distribution comprising first dissimilarity metric values associated with the respective entity characteristic and measured between the target entity and each entity in the respective first subset of entities; and determining a first benchmark score for the respective first subset of entities; associating the first benchmark score with the respective entity characteristic; setting as a first entity characteristic the entity characteristic of the set of entity characteristics associated with a highest first benchmark score; for each respective entity characteristic in the set of entity characteristics and starting with the first entity characteristic: determining a second wide distribution comprising second dissimilarity metric values associated with the respective entity characteristic and measured between the target entity and each entity in a current set of entities and comprising the respective entity characteristic; determining a plurality of second subsets of entities within the current set of entities and comprising the respective entity characteristic; for each respective second subset of entities: determining a second narrow distribution comprising second dissimilarity metric values associated with the respective entity characteristic and measured between the target entity and each entity in the respective second subset of entities; and determining a second benchmark score for the respective subset of entities; resetting the current set of entities to include only a second subset of entities in the plurality of second subsets of entities having a highest second benchmark score; and determining benchmark data for the target entity based on the current set of entities.

Clause 10: A processing system, comprising: a memory comprising computer-executable instructions; and a processor configured to execute the computer-executable instructions and cause the processing system to perform a method in accordance with any one of Clauses 1-9.

Clause 11: A processing system, comprising means for performing a method in accordance with any one of Clauses 1-9.

Clause 12: A non-transitory computer-readable medium storing program code for causing a processing system to perform the steps of any one of Clauses 1-9.

Clause 13: A computer program product embodied on a computer-readable storage medium comprising code for performing a method in accordance with any one of Clauses 1-9.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method of benchmarking a target entity, comprising:
for each respective entity characteristic in a set of entity characteristics and starting with a first entity characteristic:
determining first dissimilarity metric values associated with the respective entity characteristic and measured between the target entity and each entity in a current set of entities;
determining a wide distribution for the current set of entities, the wide distribution comprising the first dissimilarity metric values;
determining a plurality of subsets of entities within the current set of entities and comprising the respective entity characteristic;
for each respective subset of entities:
determining second dissimilarity metric values associated with the respective entity characteristic and measured between the target entity and each entity in the respective subset of entities;
determining a narrow distribution for the respective subset of entities, the narrow distribution comprising the second dissimilarity metric values; and
determining a benchmark score for the respective subset of entities;
resetting the current set of entities to include only a subset of entities in the plurality of subsets of entities having a highest benchmark score;
determining benchmark data for the target entity based on the current set of entities; and
generating for display the benchmark data determined for the target entity.

2. The method of claim 1, further comprising setting as the first entity characteristic the entity characteristic of the set of entity characteristics associated with the highest benchmark score.

3. The method of claim 1, wherein determining the benchmark score for the respective subset of entities comprises determining a negative log of a p-value of a statistical hypothesis testing whether the narrow distribution associated with the respective subset of entities is the same as the wide distribution associated with the current set of entities.

4. The method of claim 1, further comprising receiving from a user the set of entity characteristics.

5. (canceled)

6. The method of claim 1, wherein:
the respective entity characteristic comprises entity location; and
determining the first dissimilarity metric values comprises calculating a Haversine distance between the target entity and each entity in the current set of entities and comprising the respective entity characteristic.

7. The method of claim 1, wherein:
the respective entity characteristic comprises entity industry type; and
determining the first dissimilarity metric values comprises:
creating a first embedding of the entity industry type for the target entity in a multidimensional space using a machine learning model;
creating a second embedding of the entity industry type for each entity in the current set of entities and comprising the respective entity characteristic in the multidimensional space using the machine learning model; and
calculating a cosine distance between the first embedding and the second embedding; and
calculating the first dissimilarity metric values as one minus the cosine distance calculated between the first embedding and the second embedding.

8. The method of claim 1, wherein:
the respective entity characteristic comprises a financial feature over a period of time; and
determining the first dissimilarity metric values comprises calculating an Euclidean distance between the financial feature over the period of time associated with the target entity and the financial feature over the period of time associated with each entity in the current set of entities and comprising the respective entity characteristic.

9. A processing system, comprising:
a memory comprising computer-executable instructions; and
a processor configured to execute the computer-executable instructions and cause the processing system to:
for each respective entity characteristic in a set of entity characteristics and starting with a first entity characteristic:
determine first dissimilarity metric values associated with the respective entity characteristic and measured between a target entity and each entity in a current set of entities and comprising respective entity characteristic;
determine a wide distribution for the current set of entities, the wide distribution comprising the first dissimilarity metric values;
determine a plurality of subsets of entities within the current set of entities and comprising the respective entity characteristic;
for each respective subset of entities in the plurality of subsets of entities within the current set of entities:
determine second dissimilarity metric values associated with the respective entity characteristic and measured between the target entity and each entity in the respective subset of entities:
determine a narrow distribution for the respective subset of entities, the narrow distribution comprising the dissimilarity metric values; and
determine a benchmark score for the respective subset of entities;
reset the current set of entities to include only a subset of entities in the plurality of subsets of entities having a highest benchmark score;
determine benchmark data for the target entity based on the current set of entities; and
generate for display the benchmark data determined for the target entity.

10. The processing system of claim 9, wherein the processor is further configured to cause the processing system to set as the first entity characteristic the entity characteristic of the set of entity characteristics associated with the highest benchmark score.

11. The processing system of claim 9, wherein to determine benchmark score for the respective subset of entities comprises to determine a negative log of a p-value of a statistical hypothesis testing whether narrow distribution associated with the respective subset of entities is the same as the wide distribution associated with the current set of entities.

12. The processing system of claim 9, wherein the processor is further configured to cause the processing system to receive from a user the set of entity characteristics.

13. (canceled)

14. The processing system of claim 9, wherein:
the respective entity characteristic comprises entity location; and
to determine the first dissimilarity metric values comprises to calculate a Haversine distance between the target entity and each entity in the current set of entities and comprising the respective entity characteristic.

15. The processing system of claim 9, wherein:
the respective entity characteristic comprises entity industry type; and
to determine the first dissimilarity metric values comprises to:
create first embedding of the entity industry type for the target entity in a multidimensional space using a machine learning model;
create a second embedding of the entity industry type for each entity in the current set of entities and comprising the respective entity characteristic in a multidimensional space using the machine learning model; and
calculate a cosine distance between the first embedding and the second embedding; and
calculate the first dissimilarity metric values as one minus the cosine distance calculated between the first embedding and the second embedding.

16. The processing system of claim 9, wherein:
the respective entity characteristic comprises a financial feature over a period of time; and
to determine the first dissimilarity metric values comprises to calculate an Euclidean distance between the financial feature over the period of time associated with the target entity and the financial feature over the period of time associated with each entity in the current set of entities and comprising the respective entity characteristic.

17. A method of benchmarking a target entity, comprising:
for each respective entity characteristic in a set of entity characteristics:
determining first dissimilarity metric values associated with the respective entity characteristic and measured between the target entity and each entity in a current set of entities and comprising the respective entity characteristic;
determining a first wide distribution for the current set of entities, the wide distribution comprising the first dissimilarity metric values;
determining a plurality of first subsets of entities within the set of entities and comprising the respective entity characteristic;
for each respective first subset of entities:
determining second dissimilarity metric values associated with the respective entity characteristic and measured between the target entity and each entity in the respective subset of entities;
determining a first narrow distribution for respective subset of entities, the narrow distribution comprising the second dissimilarity metric values associated with the respective entity characteristic and measured between the target entity and each entity in the respective first subset of entities; and
determining a first benchmark score for the respective first subset of entities;
associating the first benchmark score with the respective entity characteristic;
setting as a first entity characteristic the entity characteristic of the set of entity characteristics associated with a highest first benchmark score;
for each respective entity characteristic in the set of entity characteristics and starting with the first entity characteristic:
determining third similarity metric values associated the respective entity characteristic and measured bet en the target entity and each entity in a current set of entities and comprising the respective entity characteristic;
determining a second wide distribution for the current set of entities, the wide distribution comprising the third dissimilarity metric values associated with the respective entity characteristic and measured between the target entity and each entity in a current set of entities and comprising the respective entity characteristic;
determining a plurality of second subsets of entities within the current set of entities and comprising the respective entity characteristic;
for each respective second subset of entities:
determining fourth dissimilarity metric values associated with the respective entity characteristic and measured between the target entity and each entity in the respective subset of entities;
determining a second narrow distribution for the respective subset of entities, the narrow distribution comprising the fourth dissimilarity metric values associated with the respective entity characteristic and measured between the target entity and each entity in the respective second subset of entities; and
determining a second benchmark score for the respective subset of entities;
resetting the current set of entities to include only a second subset of entities in the plurality of second subsets of entities having a highest second benchmark score;
determining benchmark data for the target entity based on the current set of entities; and
generating for display the benchmark data determined for the target entity.

18. The method of claim 17, wherein determining a benchmark score for the respective subset of entities comprises determining a negative log of a p-value of a statistical hypothesis testing whether a narrow distribution associated with the respective subset of entities is the same as the respective wide distribution associated with the current set of entities.

19. The method of claim 17, further comprising receiving from a user the set of entity characteristics.

20. (canceled)
